(19) United States
(12) Patent Application Publication
(10) Pub. No.: US 2019/0303953 A1
(43) Pub. Date: Oct. 3, 2019

(54) Method and software program for creation, playback, management, and monitoring of multimedia advertising campaigns on digital devices

(71) Applicant: Addreality Limited Liability Company, St. Petersburg (RU)

(72) Inventors: Sergei Galeev, St. Petersburg (RU); Aleksei Rekish, St. Petersburg (RU)

(73) Assignee: Addreality Limited Liability Company, St. Petersburg (RU)

(21) Appl. No.: 15/938,465

(22) Filed: Mar. 28, 2018

(51) Int. Cl. G06Q 30/02; G06F 8/61; H04N 21/81; H04N 21/4223

(52) U.S. Cl. CPC G06Q 30/0201; G06F 8/61; H04N 21/4223; H04N 21/812; G06Q 30/0276

(57) ABSTRACT

Method and software program for creation, playback, management, and monitoring of multimedia advertising campaigns on digital broadcast devices using a graphical interface. Creation of an advertising campaign is accomplished by development of its script on the basis of functional elements. The advertising campaign is filled with textual, graphical, audio, and video content, scheduled for playback, then sent to digital broadcast devices (media display points) for playback according to the schedule. Broadcast devices are centrally managed, including fast activation and availability monitoring. If necessary, the contents of an advertising campaign are instantly updated from a single source on all broadcast devices without stopping playback. If necessary, external data sources can be connected to an advertising campaign, such as people traffic sensors, ERP systems, etc. Data received from broadcast devices and external sources allow analyzing the efficiency of advertising campaigns from the moment the audience enters the broadcast zone to the moment of purchase. The method is intended to be implemented through a software program that includes editor, player and personal profile.

### BACKGROUND OF THE INVENTION

This invention is concerned with a method and software program for creation, playback, management, and monitoring of multimedia advertising campaigns on digital broadcast devices using a graphical interface.

There are programs that are known as the similar in purpose. They can be categorized as follows:
execution of particular tasks, e.g., only creation of multimedia advertising campaigns, only management of digital devices for broadcasting advertising campaigns, only playback of advertising campaigns, etc.;
integrated task execution using graphical interface, but only within rigidly defined advertising campaign scripts, such as an interactive polling form, video advertisement playback, etc.;
integrated task execution without rigidly defined campaign scripts, partially using a graphical interface but requiring complex technical configuration and programming skills in order to create an advertising campaign.

Usage of separate programs, each dedicated to a specific task, complicates the overall process of preparation, launch, and control of advertising campaigns, as users have to master each program separately, solve issues of their interaction, and maintain the infrastructure that emerges.

Programs with rigidly defined advertising campaign scripts are easy to learn and use, but are only suitable in cases when the user's advertising campaign falls into the type represented in the program. Changes and extensions of campaign scripts are beyond the scope of such programs, which makes it impossible to adapt the campaign according to user demands.

Programs with no constraints on scripts usually provide the required degree of flexibility and enable users to implement complex campaign scenarios. The downside of this type of programs is their complexity and user-unfriendliness, as the flexibility of advertising campaigns is achieved at the cost of indispensability of programming. Thus, a user of such program has to possess programming skills in order to master the script language employed and use it to develop the advertising campaign scenario.

It is worth noting some problems of the programs described above that follow from their characteristics.

Existing programs do not allow their users to set an arbitrary interaction of advertising campaign elements between digital devices via graphical interface. Such a capability can be used for synchronized playback of video walls, adjustment of campaign playback depending on the visitor entering the store, etc.

Existing programs do not allow their users to set the rules for real-time adaptation of advertising campaign script and contents for the current audience via graphical interface. Such a capability can be used for display of different advertising content depending on the number of shoppers present.

Existing programs do not include or include only a limited set of features for monitoring and analysis of advertising campaigns. Such features are either limited to performance analysis of embedded linear scripts or require modification of the program in order to be able to account for freeform factors. Most of the features like A/B-testing of campaigns, consideration of audience engagement, analysis of interconnection between advertising campaign and commodity heading are not available for use in the graphical interface of existing programs.

### BRIEF SUMMARY OF THE INVENTION

This invention is intended for solution of the problems outlined above, through implementation of method and software program enabling creation, playback, management, and monitoring of multimedia advertising campaigns on digital broadcast devices using a graphical interface

The 1^{st} Part of the Claims includes a method for creating multimedia advertising campaigns. A method is suggested whereby a user creates an advertising campaign by developing a script for its playback. Such script may include content, components, triggers, and directed links between its elements. The content—text, sound, images, and video—can be both static and dynamic, obtained from an external source selected for the purpose. The components are intended for gathering, processing, and playback of content. The triggers allow linking occurring events to the script or content of the campaign being changed. For instance, when a male customer approaches a broadcast device, the background screen of the advertising campaign is replaced with a video targeted at the male audience. Using directed links between the script elements outlined above allows setting up the advertising campaign playback sequence. Use of the above-listed elements makes the process of creation of an advertising campaign much simpler and easier. The user will focus on the creative process instead of thinking over technical details.

The 2^{nd} Part of the Claims includes a method for control of digital devices intended for playback of advertising campaigns. A centralized control method for such devices is suggested, covering connection, configuration, and availability monitoring. Control also includes the capability of assigning freeform additional information to devices for their classification and convenient management. Centralized management of broadcast devices simplifies maintenance and control of advertising space used.

The 3^{rd} Part of the Claims includes a method for playback of advertising campaigns on digital broadcast devices. A method is suggested whereby the designed advertising campaign is centrally deployed to one or more broadcast devices, after which its playback starts. With this method, it is possible to take into account specific details of playback assigned in the script to adjoining broadcast devices, e.g., for organization of video walls. The method helps to speed up deployment and testing of advertising campaigns on broadcast devices.

The 4^{th} Part of the Claims includes a method for advertising campaign management. A method is suggested whereby a user is able to plan playback of one or more advertising campaigns, change a campaign script or a specific element of it, update advertising campaign content without stopping playback or modifying the script, stop/resume playback on broadcast devices, delete the campaign. The method will facilitate the process of simultaneous management of a large number of advertising campaigns.

The 5^{th} Part of the Claims includes a method for monitoring and analysis of advertising campaigns. A method is suggested for taking into account various performance indicators of advertising campaigns. Such indicators are primarily audience-based and include: customer engagement, gender, age, optimal time for advertisement playback. In addition to audience-based indicators, a provision is made for analysis of interrelations between number of sales and the advertising campaign, as well as for monitoring and interpretation of any other data obtained from external source integrated into the campaign, like foot traffic sensors, etc. The method also provides for A/B-testing of campaigns. Reliance on findings of advertising campaign analysis enables the user to make decisions on modifications of campaign elements or of the overall corporate marketing strategy, for the purpose of improving efficiency.

The 6^{th} Part of the Claims includes software with graphical user interface that serves for implementation of the above mentioned methods. A software platform is suggested, including the following elements:
Editor—for creation and management of advertising campaign scripts, centralized control of broadcast devices;
Player—for playback of advertising campaigns on broadcast devices, local control of broadcast devices;
Content Management System (CMS)—for management, monitoring, and analysis of advertising campaigns, control of broadcast devices;
Backend—for organizing interaction between the above-listed components.

Use of software with graphical user interface will make it possible to facilitate and speed up development of advertising campaigns. Use of Player as a separate component will allow for looser technical requirements to the broadcasting equipment, as the Player will not be overloaded with extra functions. Use of a CMS separate from the Editor will allow for on-the-fly updating of existing advertising campaigns without changes to other script elements.

### BRIEF DESCRIPTION OF THE SEVERAL VIEWS OF THE DRAWING

The foregoing and other objects, features and advantages of the present invention will become more readily apparent from the following detailed description of a preferred embodiment of the present invention that proceeds with reference to the appending drawings:

FIG. 1 depicts the conceptual diagram of the program;

FIG. 2 presents a tentative algorithm for creation of an advertising campaign;

FIG. 3 is an example of workspace for creation of scripts;

FIG. 4 is an example of workspace for creation of scripts containing several components and triggers;

FIG. 5 is an example of interface for component setup;

FIG. 6 is an example of interface for the Interface Editor component setup;

FIG. 7 is an example of interface designed in the Interface Editor;

FIG. 8 is an example of use of zones in a component intended for interface creation, and an example of video wall setup using zones;

FIG. 9 is an example of interface for trigger setup;

FIG. 10 is an example of workspace for creation of scripts prompting to select a component connected (linked) to the currently edited component or trigger;

FIG. 11 is an example of interface for advertising campaign script setup;

FIGS. 12 and 12a is an example of workspace for creation of scripts containing several interconnected components and triggers;

FIG. 13 presents a possible algorithm for connecting a broadcast device;

FIG. 14 is an example of interface of the CMS;

FIG. 15 is an example of interface for management of broadcast devices from the CMS;

FIG. 16 is an example of interface for connecting a broadcast device in the CMS and the generated code;

FIG. 17 is an example of interface of a broadcast device used to connect it to the program;

FIG. 18 is an example of interface for on-site setup of a broadcast device;

FIG. 19 is an example of Editor control panel;

FIG. 20 is an example of simplified interface for deployment of an advertising campaign on broadcast devices;

FIG. 21 is an example of interface for management of advertising campaigns;

FIG. 22 is an example of interface for planning of advertising campaigns;

FIG. 23 is an example of interface for monitoring of advertising campaigns;

FIG. 24 is an example of interface for viewing logs.

### DETAILED DESCRIPTION OF THE INVENTION

The preferred embodiment of the method and the software program for creation, playback, management, and monitoring of multimedia advertising campaigns on digital broadcast devices using a graphical interface is further described below with links to the figures attached.

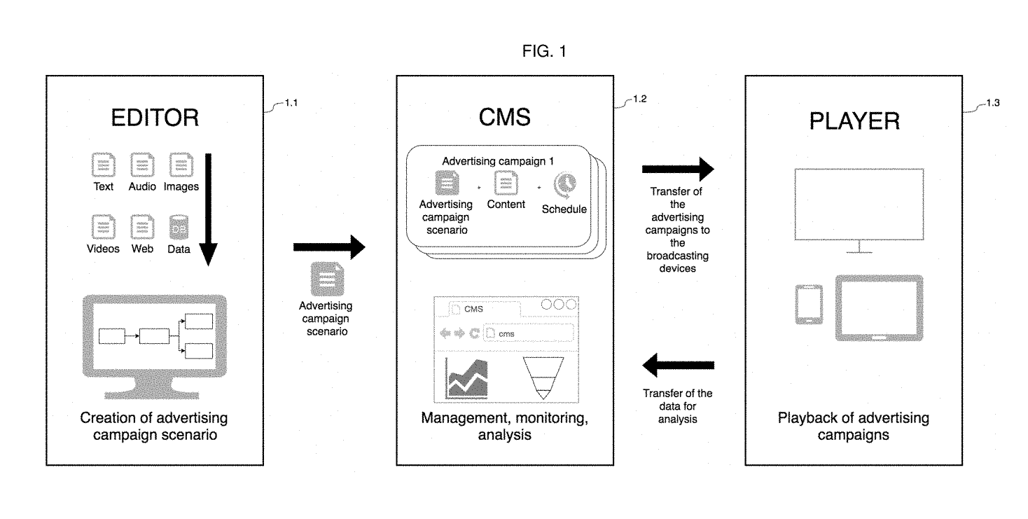

FIG. 1 contains the conceptual diagram of the software program for implementation of the method. The program includes three main components—Editor 1.1, CMS 1.2, Player 1.3.

Editor 1.1 is intended for creation of advertising campaign scripts. CMS 1.2 is intended for management and monitoring of advertising campaigns, control of broadcast devices. Player 1.3 is intended for playback of advertising campaigns on broadcast devices. In order to simplify work with the program, Editor 1.1 can be equipped with functions duplicating some of the capabilities of CMS 1.2 concerned with management of advertising campaigns and broadcast devices.

In general, the following order of operations involving components is assumed:
1. The user creates an advertising campaign script 1.1 and uploads it into CMS 1.2.
2. If necessary, the user supplements the advertising campaign script with content from CMS 1.2.
3. The user schedules playback of the advertising campaign script in CMS 1.2, launches the advertising campaign on broadcast devices.
4. Player 1.3 plays the advertising campaign on selected broadcast devices according to the script.
5. The user monitors the advertising campaign and the broadcast devices in CMS 1.2.
6. If necessary, the user supplements the advertising campaign script with content from CMS 1.2.

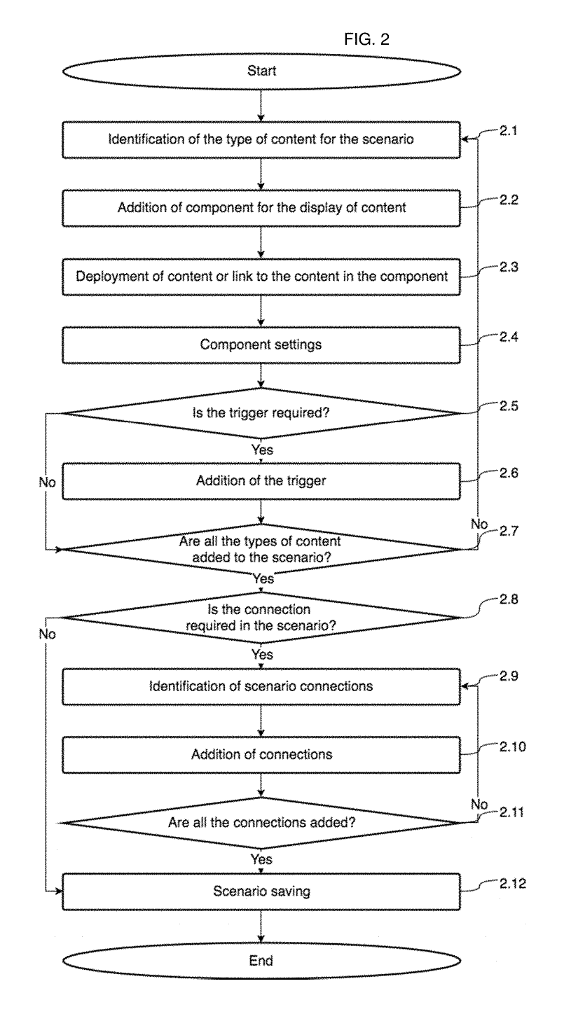

FIG. 2 presents a tentative algorithm for creation of an advertising campaign script. An advertising campaign script may include the following:
1. content
2. components for content gathering, processing, and playback;
3. triggers for setting up rules of the advertising campaign script responses to external events;
4. links between script elements for setting the playback sequence.

At step 2.1, the user in charge of creation of the advertising campaign shall define types of content to be used in the script.

Depending on the type required, at step 2.2, the user adds a component to the script, For instance, for playback of background tune the user adds the component that enables playback of audio fragments.

At step 2.3, the user places content (or links to sources from which this content will be transmitted) into the added component.

At step 2.4, the user configures the component.

At step 2.5, the user determines the necessity for using triggers. If response to external events is needed, at step 2.6 the user adds a corresponding trigger to the script. If there is no need for triggers, go to step 2.7.

At step 2.7, the user verifies if all types of content have been accounted for and all components for content playback have been added. If everything is in, go to step 2.8. If something has not been added, return to step 2.1.

At step 2.8, the user determines if links within and between components and triggers of the script are required. If they are, go to step 2.9. Otherwise, go to step 2.12.

At step 2.9, the user determines the script playback sequence.

At step 2.10, the user adds links within components, between components, between components and triggers. In this way the script acquires a playback sequence.

At step 2.11, the user verifies if all links have been added. If all links have been added, go to the last step. If not all links have been added, return to step 9.

At step 2.12 the user saves the script.

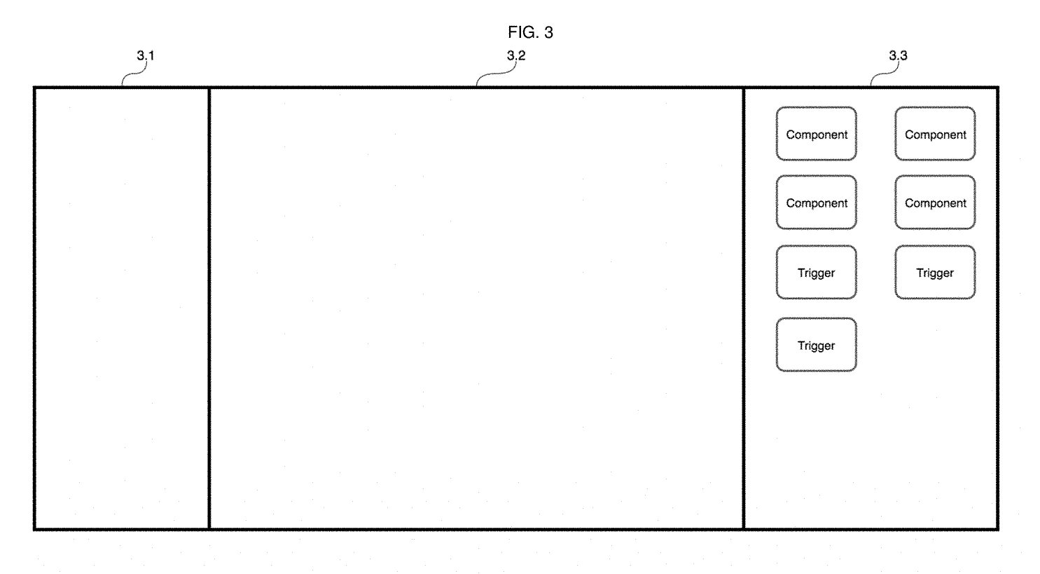

FIG. 3 presents an example of workspace for creation of scripts. The workspace includes Media Library 3.1, main workspace 3.2, and library of available components and triggers 3.3.

Library 3.1 contains the list of all content added to the advertising campaign script. Library of components and triggers 3.3 contains the list of components and triggers available for adding to the script.

Main workspace 3.2 is used for designing the script—placing components, triggers, and links between them.

The program includes the following components:
Media Gallery;
Sound panel;
Interface Editor;
Web Frame;
Application Container.

Media Gallery and Sound panel components enable display and playback of multimedia content: images, video recordings, audio fragments.

Web Frame is used for display of local HTML code or content of web pages or parts thereof.

The Interface Editor component is intended for creation of interactive interfaces to be available on broadcast devices during playback of advertisement projects.

The Application Container component enhances the functionality of the script through integration of external applications.

The program contains the following triggers:
Face Detection;
Motion Detection;
Face Recognition;
Presence Controller;
Scheduler.

When one of the above-listed events occurs or a set date and time comes, the script will launch the components required.

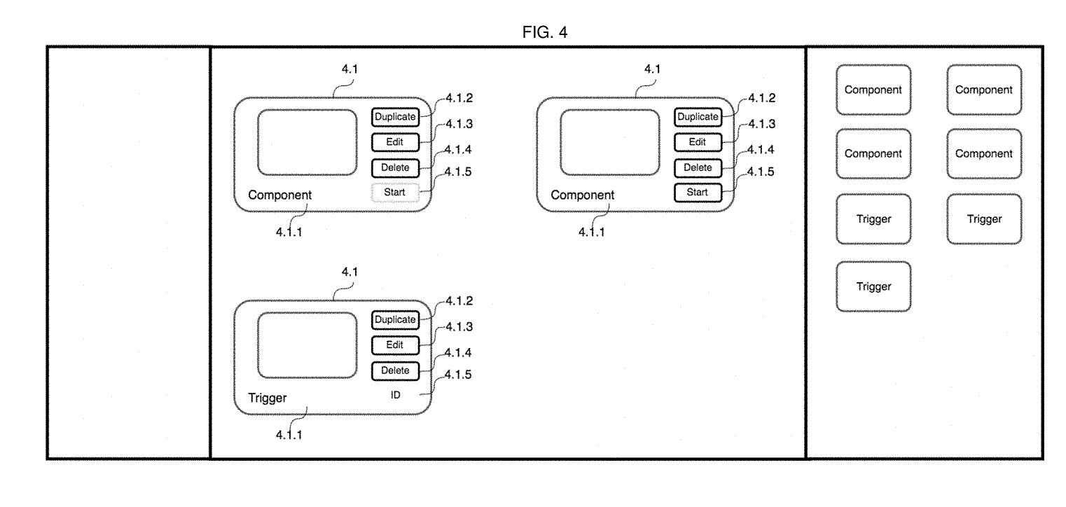

FIG. 4 presents an example of workspace for creation of scripts containing several components and triggers 4.1. Each component and trigger 4.1 situated within the main workspace has a title 4.1.1, as well as buttons used to edit the script:
Copy 4.1.2, for creating a copy of the component or trigger in the script;
Edit 4.1.3, for adjusting the component or trigger;
Delete 4.1.4, for removing the component or trigger from the script.

Components may additionally have a Make Start button 4.1.5, used to select a components with which playback of the script shall start.

Triggers may additionally display an ID of the device 4.1.6 used by the trigger. For instance, the Face Recognition trigger will display ID of the video camera used in its work.

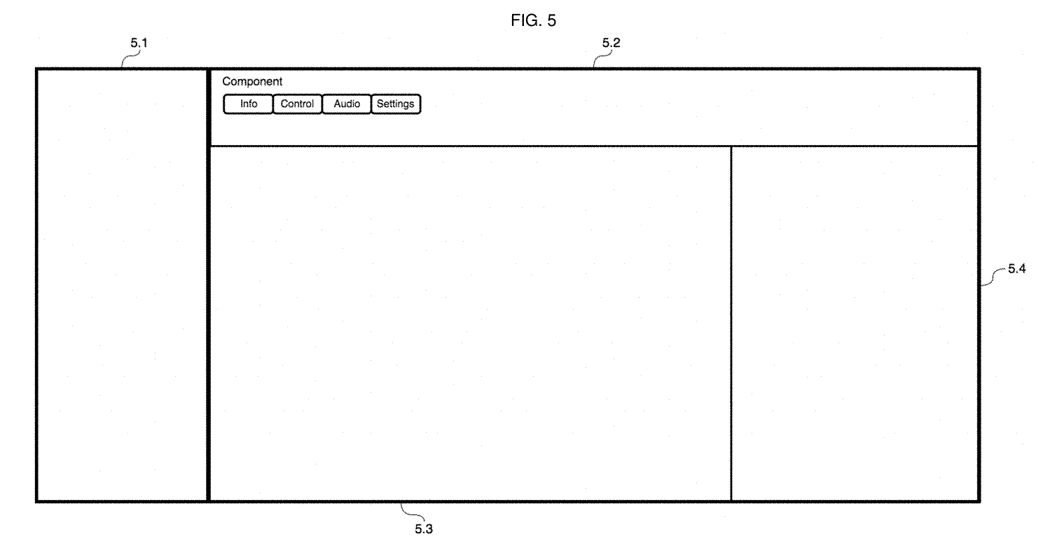

FIG. 5 presents an example of interface for component setup. The interface includes Media Library 5.1, general settings panel 5.2, workspace 5.3, component settings panel 5.4.

Library 5.1 1 contains the list of all content added to the advertising campaign script.

General settings panel 5.2 enables setting up:
general data, such as component title, description, and color;
timer settings used to switch to a different component of the script;
links to trigger; when a certain event occurs, the trigger will be activated and the script will switch from the edited component to a different one;
background audio settings, for the audio to be played during component playback;
saving component settings upon restart, preload type for broadcast devices resource saving, switching the background mode of component operation on/off.

Workspace 5.3 and settings panel 5.4 are intended for configuration of component features. Contents of workspace 5.3 and settings panel 5.4 vary depending on the component being edited.

Workspace of the Media Gallery component displays the content to be played in the component.

Media Gallery settings panel enables the following:
1. Managing the component playlist—add, copy, and remove multimedia content.
2. Each component playlist element can be a link to a different component within the same advertising campaign. A connection will be established between the currently edited component and the one selected. Upon tapping the broadcast device screen, the user will be redirected to the specified component.
3. Content playback settings—duration of image display, content size scaling, background color, repeat and shuffle modes, redirecting user to a different component when playback is over, effects at playback elements change, the option of scrolling playback elements by tapping the broadcast device screen.
4. Setting up display of multimedia advertising unit at specified intervals, putting the playlist on a pause.

Workspace of the Sound panel component enables the following:
1. Setting up default sound volume level for primary audio recordings, advertising units, and the mike.
2. Setting up playback of audio multimedia advertising units at specified intervals, putting the primary playlist on a pause or dialing it down in volume.
3. Setting up playback of audio inserts at specified intervals, putting the primary playlist on a pause or dialing it down in volume.
4. Setting up mike with dialing the primary playlist down in volume.

Sound panel component settings panel contains playlist controls—add, remove, reorder, play elements.

Workspace of the Web Frame component enables the following:
1. Configuration of web content to be displayed—external page or .html file, URL or HTML code, security settings, web frame reload rules, engine used for display, use of cash and cookies, configuration of redirection from web frame URLs to advertising campaign script components.
2. Setting up Request method for work with web frames, passed parameters, and their values.
3. White- or blacklisting web URLs.

Workspace of the Application Container component contains settings of the type of integrated application and a link to such application. For instance, for an SWF application, a link to the file is necessary. Android application requires an ID, etc.

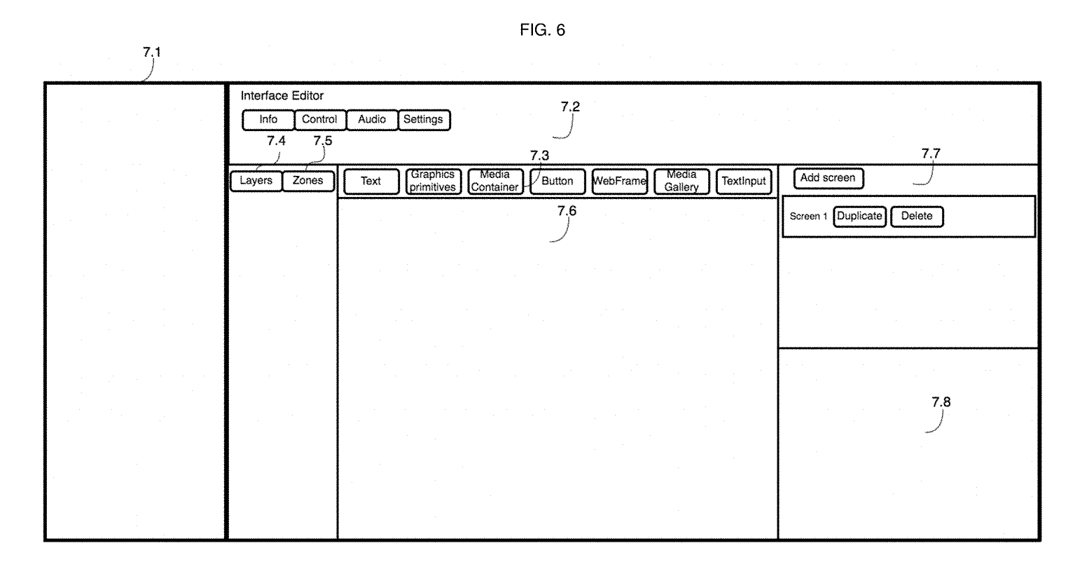

FIG. 6 is an example of interface for the Interface Editor component setup;

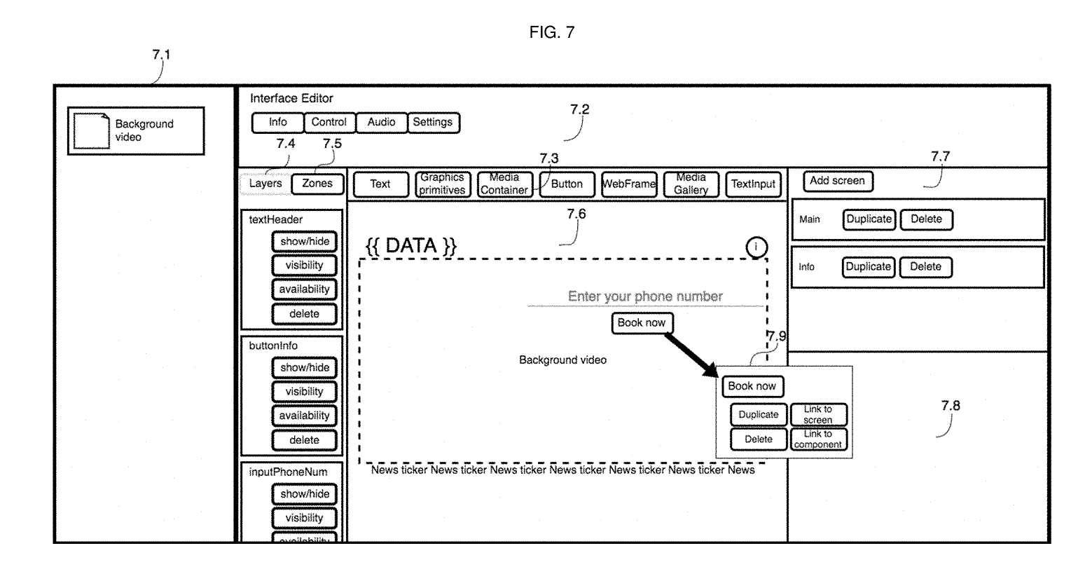

FIG. 7 is an example of interface designed in the Interface Editor; Interface for the setup of the Interface Editor component includes Media Library 7.1, general settings panel 7.2, layers panel 7.3, added layers panel 7.4, zones panel 7.5, workspace 7.6, screens panel 7.7, and component and layers settings panel 7.8. Library 7.1 general settings panel and 7.2 of the components are similar to those described above.

Layers panel 7.3 contains layers (elements) that can be used in interface design. The following layers are available:
Text—for adding text captions,
GraphicalPrimitives—for adding rectangular and oval-shaped elements and other graphical primitives,
MediaContainer—for adding images and videos, transmissions from TV tuner or camera, live streaming, image sequences,
Button—for adding buttons,
WebFrame—for adding web content or HTML code,
MediaGallery—for adding multimedia content, such as images and videos;
TextInput—for adding text input fields.

The interface created may consist of one or more screens, each of which may contain several different layers. Switching between screens is set up using layers, e.g., one can add a Button layer and set up redirect to another screen of the interface—when a user clicks or taps a button on a broadcast device, the specified interface screen will be displayed on the device.

List of current interface screens is displayed in the screens panel 7.7. In addition to showing the list, the panel enables the user to add, copy, delete, and rename screens, as well as to reorder them relative to each other. Layers added into the selected screen are shown in the added screens panel 7.4. For each layer in the panel, it is possible to set up:
name of the layer;
screens—which screens the layer shall be displayed at;
visibility—display or hide the layer;
no-edit—to lock the layer on screen and close it for edits.

For some layers, panel 7.4 will additionally display content added to them, e.g., for the Gallery layer, the list of added images and videos will be shown.

Also, the added layers panel 7.4 allows for deletion of layers from screen.

Upon addition, layers are placed in the workspace 7.6. For each layer within the workspace 7.6 it is possible to change its location and size. In addition, the following actions are available for each layer:
copying layer with all settings;
setting a link to interface screen—when a customer clicks or taps the layer on a broadcast device, the specified interface screen will be displayed on the device;
setting a link to advertising campaign script component—when a customer clicks or taps the layer on a broadcast device, the specified component of the script will be launched;
deleting a layer from interface.

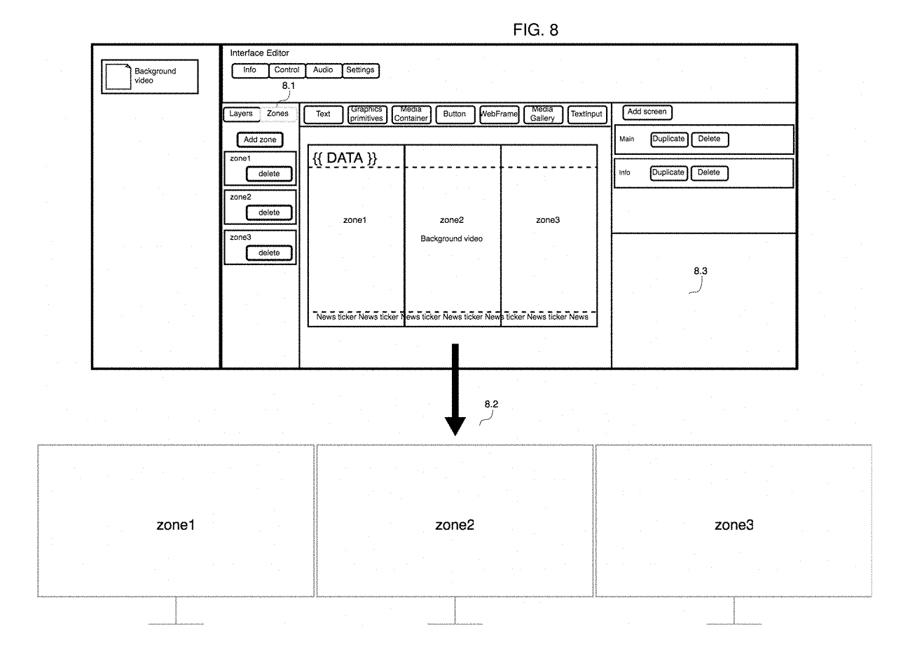

FIG. 8 presents an example of use of zones in the Interface Editor component, as well as an example of video wall setup using zones;

Zones panel 8.1 contains a list of zones situated on the screen. Zones are intended for synchronization of content on several adjacent broadcast devices. For instance, when a video wall 8.2 is to be set up by putting together three broadcast devices, one device will be showing the left part of the video, the second one will be showing the middle part of the video and the third one will be showing the right part of the video.

Adding and deleting, as well as renaming zones are done in the zones panel.

Configuration of screens, zones, used layers, and layer content is done in settings panel 8.3. Depending on the element currently edited, contents of the panel will vary.

Screen settings include:
screen background color;
automatic switching to a different screen or component of the script, by timer;
screen animation;
actions to be performed when the screen state changes.

Screen states include:
in the beginning of show;
in the end of show;
in the beginning of hide;
in the end of hide;
on receive;
on barcode scan;
on click.

Actions that can be performed upon screen state change are described below.

Layer settings include:
layer size and location on screen;
possibility to move the layer on the broadcast device screen, for creation of interactive elements;
binding to other layers;
layer display effects, such as 3D rotation, shadow, blurring, trembling, scaling, etc;
animation settings;
actions to be performed on click or on empty playlist.

Actions that can be performed upon clicking on the layer are described below. Each layer also contains layer-specific setting.

The Text layer has the following adjustable settings:
type or source of the text—caption, time, data, combined options, plain text, rss, xml, data from CMS;
formatting—font, format, font size and interline spacing, alignment, etc.;
animation, e.g. for setting up a running line, duration of animation.

Layers of graphical primitives allow for such settings as figure color and borders, transparency, rounding-off angles, etc.

When images and videos are added, the MediaContainer layer has the following settings:
content source—local, link to file, plain text, rss, xml, CMS;
content scaling rules;
content transparency.

When transmission from a TV tuner is added, the MediaContainer layer has the following settings:
selection of TV signal transmitting device;
video interface type—analog, composite, Svideo, HDMI;
content scaling rules;
content transparency.
image resolution;
sound volume level.

When transmission from a video camera is added, the MediaContainer layer has the following settings:
selection of video image transmitting device;
content scaling rules;
content transparency.
image resolution;
sound volume level.

When live streaming is added, the MediaContainer layer has the following settings:
source type—HTTP, UDP, other;
codec;
link to stream;
content scaling rules;
content transparency.
image resolution;
sound volume level.

When image sequence is added, the MediaContainer layer has the following settings:
adding images;
frames per second;
content scaling rules;
content transparency.
repeat content;
toggle automatic optimization of content for image improvement.

For the Button layer it is possible to set up background images for the button in the default state and upon rollover. There are also settings to adjust button transparency and rules for background image scaling.

The WebFrame layer has the following settings:
content—web page or .html file;
web page URL or HTML code;
layer transparency;
engine used for displaying content;
display of web frame only or together with browser controls;
web frame reload rules;
use of mobile browser for display of mobile versions of websites (if present).

The MediaGallery layer has the following settings:
adding primary or advertisement content to the layer or receiving content from the CMS;
duration of images display;
content scaling;
transparency;
repeat content;
shuffle content;
switching to a different component screen or a different script component within the same advertising campaign when the layer playlist is empty;
content display effects;
changing layer content when broadcast device screen is clicked or tapped;
toggle content display synchronization with other layers;
time interval for displaying advertisement content in the layer.

The Text input layer is intended for gathering data entered by customers on broadcast devices. Each input field must be connected to some form created in the Editor. A form may contain one or more input fields. Data entered via input fields are further displayed in the CMS, grouped by forms and fields.

The Text input layer has the following settings:
selection of an available form or creation of a new one;
assigning name to a variable in which the entered value will be stored;
input type—text, number, e-mail address, phone number, url;
whether the field is obligatory;
hint to user—value shown by default;
content formatting within the field—font, animation, font color and size, etc;
input formatting.

For screens, when their state changes, and for layers, when they are clicked on or when their playlists are empty, it is possible to set up automatically triggered actions. Such actions include:
set variable value to form;
send form to account (CMS);
clear form
send message to broadcast devices, in order to activate certain processes;
show a selected layer on screen (only for added layers that have been previously hidden);
hide a selected layer from screen (only for added layers);
change property from;
change property to;
go to screen;
set broadcast device display state;
device action (turn off or reboot);
player action (reboot);
OS action (activation of the previous application or window of the broadcast device OS.

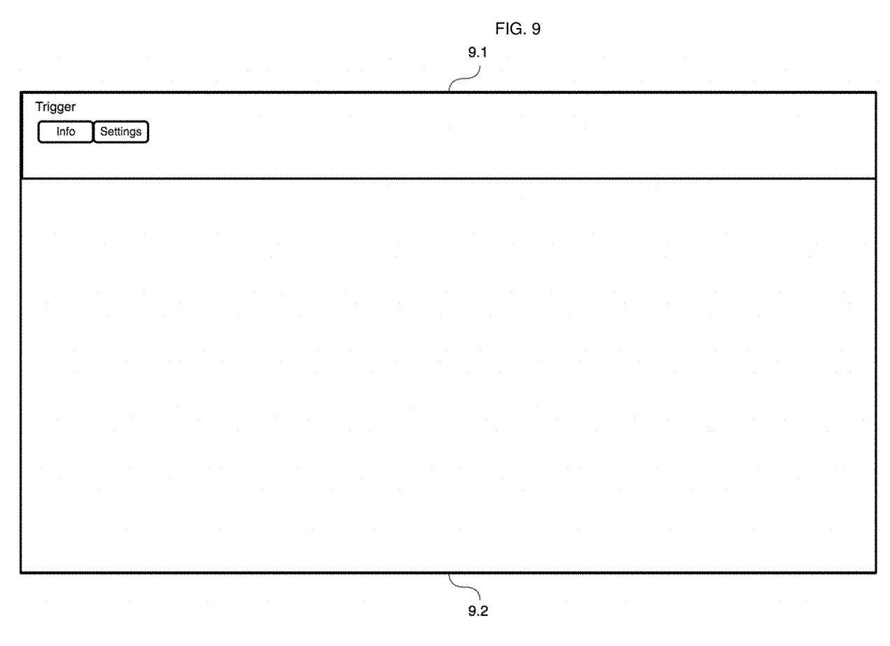

FIG. 9 presents an example of interface for trigger setup. The interface includes general trigger settings panel 9.1 and workspace 9.2.

General trigger settings panel 9.1 enables setting up:
general data, such as trigger title, description, and color;
saving trigger settings upon restart, preload type for broadcast devices resource saving, switching the background mode of trigger operation on/off.

Contents of workspace 9.2 vary depending on the trigger currently edited.

In the workspace of the Face Detection trigger, the user can select the component to be launched on broadcast device screen after a face is caught in the camera.

Workspace of the Motion Detection trigger enables the following settings:
selection of the component to be launched on broadcast device screen after motion is caught in the camera;
motion level, for input of the number that determines the change in the frame for the transition between components.

Workspace of the Face Recognition trigger enables the user to select the components to be launched based on the results of gender and age analysis. The latter is based on recognition and analysis of customers' faces caught in video cameras of broadcast devices. The trigger allows the user to add an event including:
name;
gender;
exact age or age range;
component, the advertising campaign will switch to upon recognition of a face conforming to the above criteria.

When the event occurs, i.e. upon recognition of a face conforming to the specified conditions, the trigger will launch the component selected.

For ease of editing, any event can be copied or deleted.

Workspace of the Presence Controller enables the user to select the component to be launched on the broadcast device screen after motion has been detected by presence sensor.

Workspace of the Scheduler trigger enables the user to select the components to be launched according to the specified schedule. The trigger allows the user to add an event including:
name;
date and time of event endpoints;
playback duration—all day until midnight, specified time interval, or the interval between event endpoints;
periodicity of repeating;
component the project shall switch to at the specified time.

When the event occurs, i.e. at the time and date conforming to the specified conditions, the trigger will launch the component selected.

For ease of editing, any event can be copied or deleted.

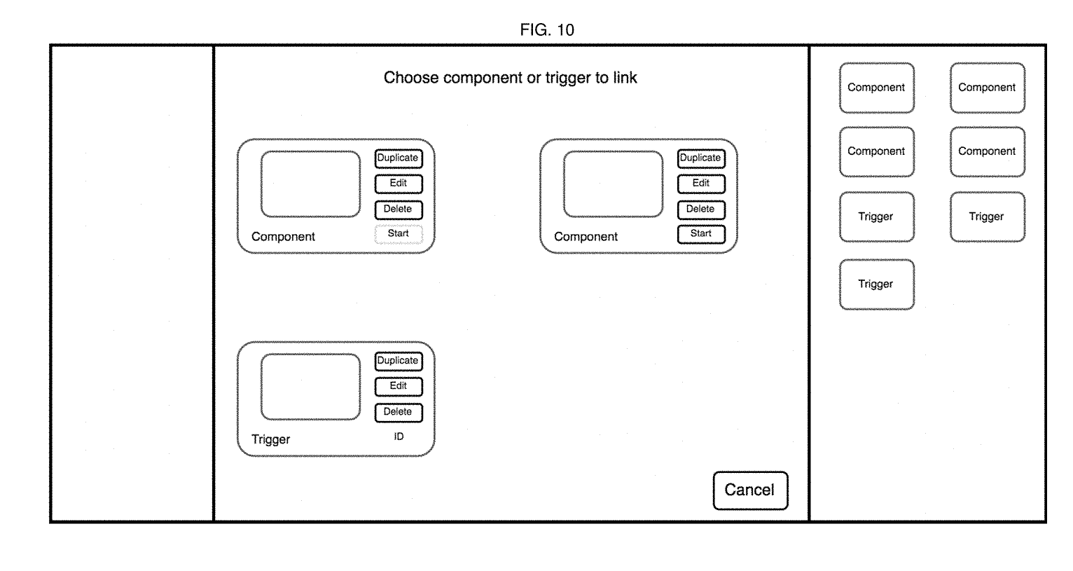

FIG. 10 presents an example of workspace for creation of scripts prompting to select a component connected (linked) to the currently edited component or trigger. Links between components and triggers are established during script editing, when the relevant settings, some of which have been described above, are changed.

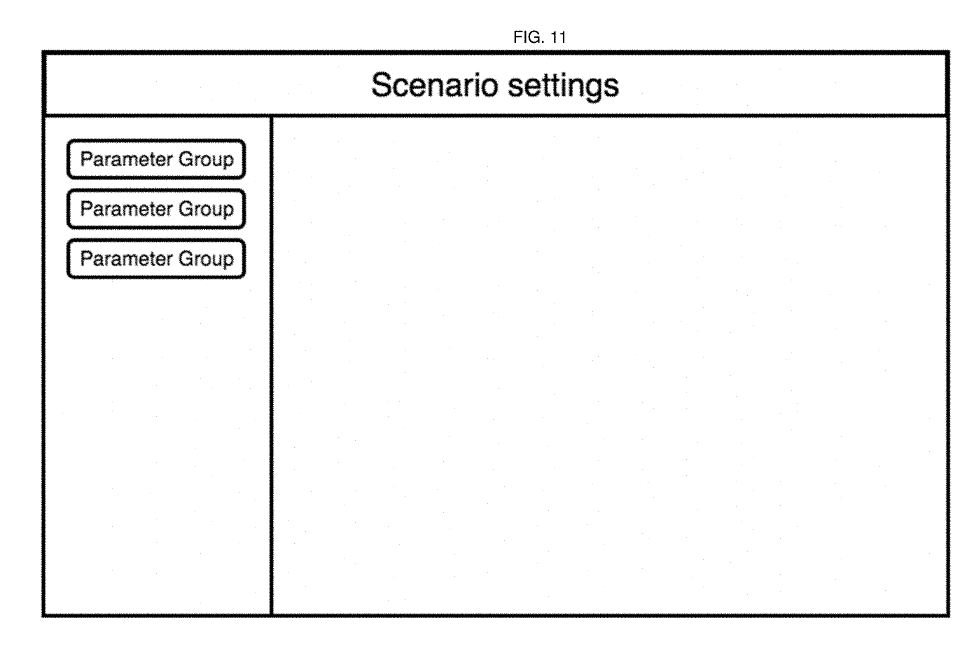

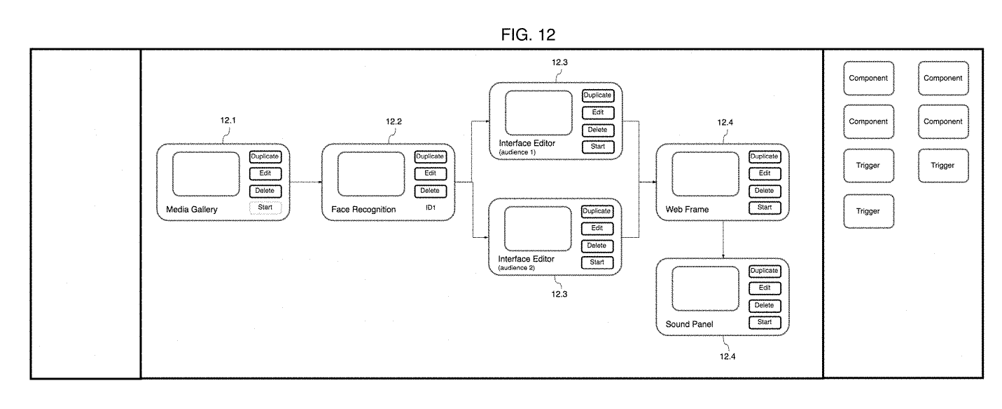

FIG. 11 presents an example of interface for advertising campaign script setup. Each script contains the following set of features:
Title;
Project ID;
Description;
Icon, for serviceable designation of the advertising campaign script;
Project resolution;
Adaptive (toggles automatic adaptation of the script content for screen resolution of broadcast devices;
Border—if set, the advertising campaign script will be displayed on broadcast devices with a border;
User inactivity timeout, upon expiration of which the advertising campaign will be reloaded on the broadcast device—e.g., if customer has left the broadcast device, after a set period of time the start component of the script will be launched;
Forms (described above), used in the script;
Devices, used by the script triggers;
Zones (described above), used in the script, with the options of export and import;
Command line API, intended for sending commands to players on broadcast devices via input/output interface of their Os; such commands can be used for management of advertising campaign script.

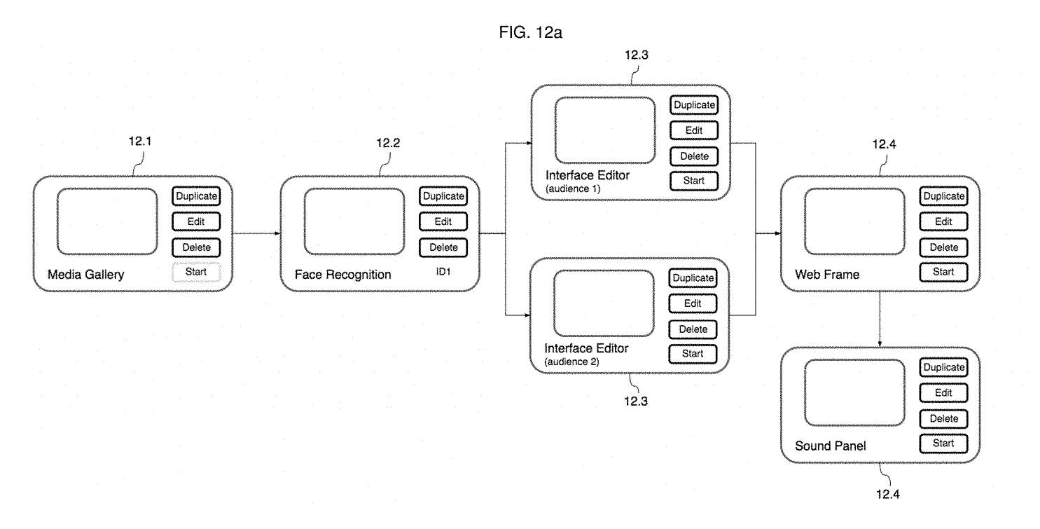

FIGS. 12 and 12a presents an example of workspace for creation of scripts in which several interconnected components and triggers have been placed. Comments to the Figure:
1. By default, broadcast devices display content from the start component Gallery 12.1
2. If a person appears within the broadcast device camera view, Player uses Face Recognition trigger 12.2 in an attempt to determine their gender and age and, depending on the results, switches from the start component 12.1 to the required component 12.3. The customer sees content relevant to them displayed on screen.
3. The customer engages in interaction with the interface 12.3, if they so want. Clicking/tapping some layers changes contents of the screen to respective components 12.4.
4. When the customer finishes working with the interface, timer is set for return of the advertising campaign to its start component 12.1—the User inactivity timeout setting (described above).

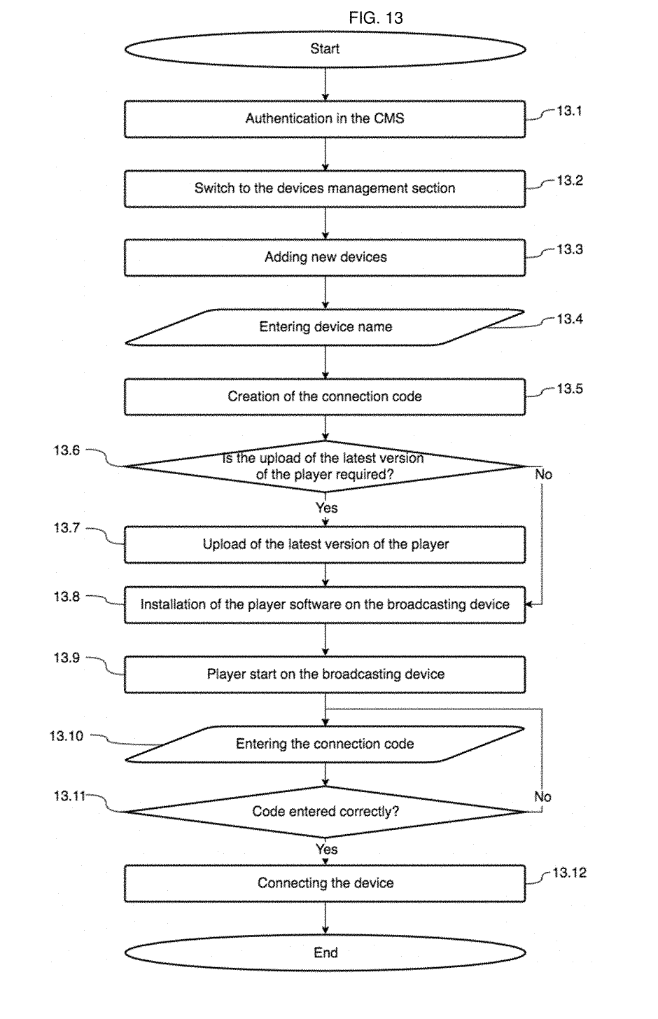

FIG. 13 presents a possible algorithm for connecting a broadcast device.

At step 13.1, the user in charge of broadcast device connection undergoes authentication in CMS.

At step 13.2, the user goes to the devices management section.

At step 13.3, the user adds a new broadcast device.

At step 13.4, the user enters name of the added device.

At step 13.5, an access code is generated, which later has to be entered in to the broadcast device.

At step 13.6, the user determines whether it is necessary to download the latest version of Player software. If download is required, the user downloads the program distribution at step 13.7. Otherwise, go to step 13.8.

At step 13.8, the user installs Player software the broadcast device.

At step 13.9, the user launches Player on the broadcast device.

At step 13.10, the user enters the access code generated at step 13.5.

At step 13.11, access code verification is performed. If the code has been entered correctly, go to 13.12. Otherwise, return to 13.10.

At step 13.12, a connection between the broadcast device, CMS, and Editor is established, while the broadcast device becomes visible in the respective section if CMS and in Editor and available for management and playback of advertising campaigns.

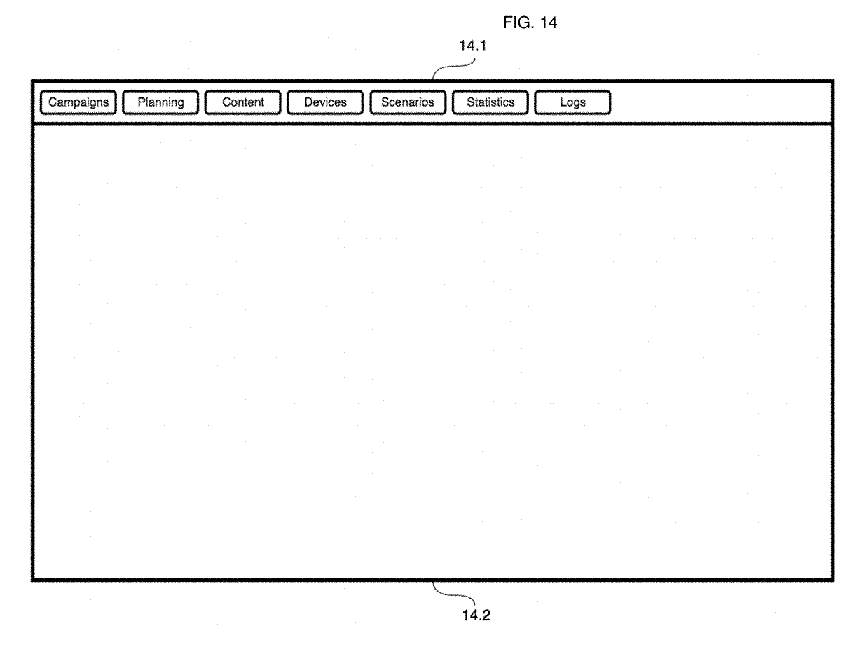

FIG. 14 presents an example of interface of the CMS. The interface includes:
navigation panel 14.1, for access to CMS sections;
main workspace 14.2, the content of which varies depending on the section selected.

Navigation panel 14.1 includes the following main sections of CMS:
Campaigns—for management of advertising campaigns;
Mediaplan—for planning of advertising campaigns;
Content—for adding content to CMS;
Devices—for management of broadcast devices;
Scripts—for management of advertising campaign scripts;
Statistics—for monitoring and analysis of advertising campaigns;
Logs—for viewing logs of the program and broadcast devices.

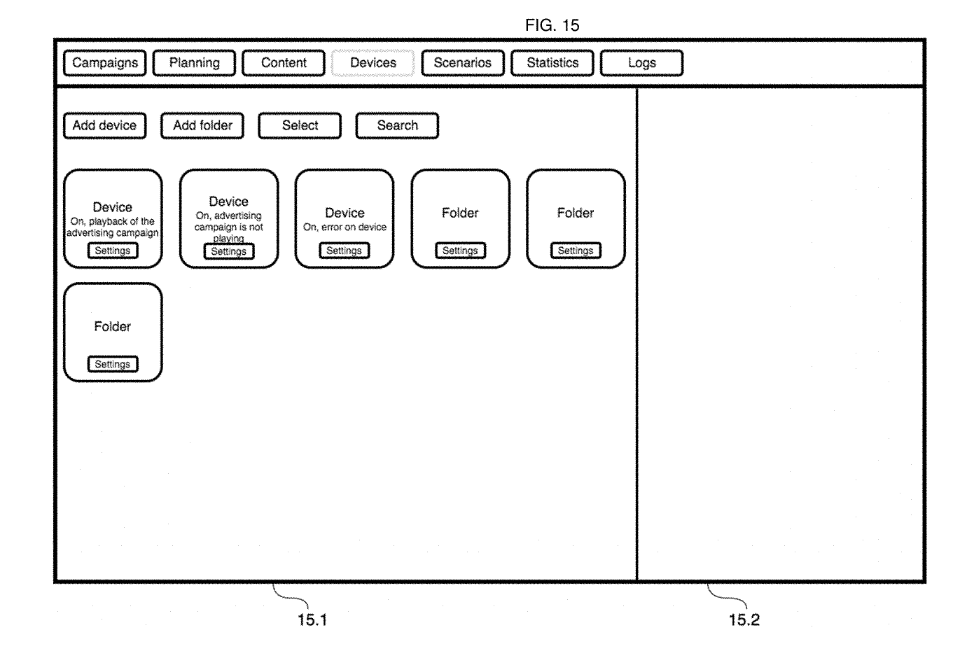

FIG. 15 presents an example of interface for managing broadcast devices from CMS. Main workspace of the interface includes:
device list area 15.1;
device management area 15.2.

The interface enables the following:
connection of broadcast devices to the program;
grouping broadcast devices by folders and tags;
broadcast device search;
adding notes about broadcast devices;
management of broadcast devices;
disconnection (deletion) of broadcast devices from the platform.

Icon of each broadcast device reflects its current status—whether there is connection with CMS and Editor, whether an advertising campaign is played.

Broadcast device management includes:
updating Player software;
rebooting device;
restarting Player;
turning device off;
viewing logs;
removing broadcast device from CMS and Sphere;
setting operation hours during which broadcast device will display advertising campaigns;
setting time periods for downloading content to device;
activation (focusing) of Player window on broadcast device screen;
setting broadcast device sound volume level;
puttingdevice into sleeping mode;
device hybernation;
autoconfiguration of device for quick launch of advertising campaign;
turning Player autostart on/off;
turning Kiosk mode on/off; in Kiosk mode access to Player menu at the device itself is blocked;
turning customer photo sending on/off;
turning broadcast device OS hotkeys on/off;
if applicable, broadcast device camera rotation for a specified angle;
turning Face Recognition trigger on/off (described above) on the broadcast device;
turning upload of display and views statistics on/off;
turning Player background mode on/off;
turning upload of camera statistics on/off;
stopping/resuming advertising campaign playback;
turning broadcast device screen on/off;
turning broadcast device screen on/off for TV panels via the RS-232/COM port;
scheduled automatic execution of one or more of the above-listed commands.

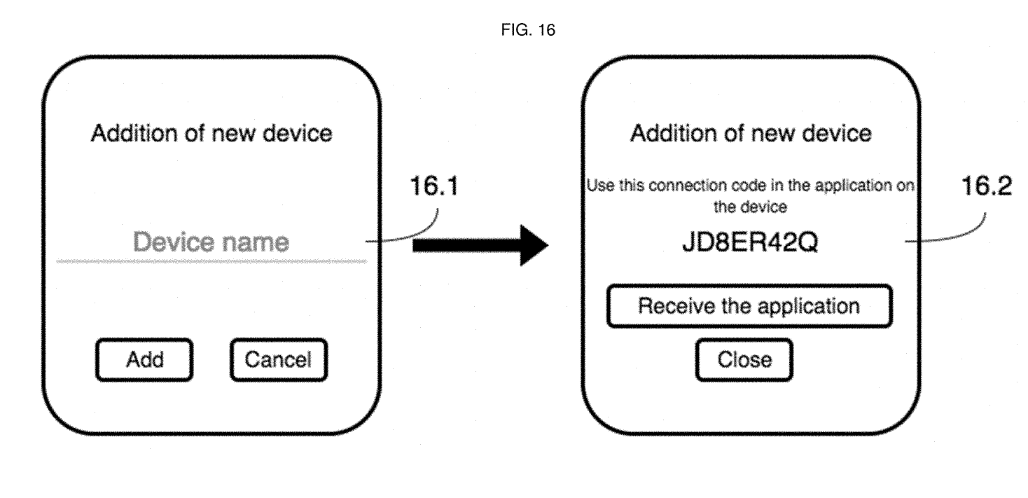

FIG. 16 presents an example of interface for connecting a broadcast device in the CMS and the generated code. When a device is added, it must be assigned an arbitrary name 16.1 for the purposes of identification in the list of devices. After that an access code 16.2 is generated, to be used for connection.

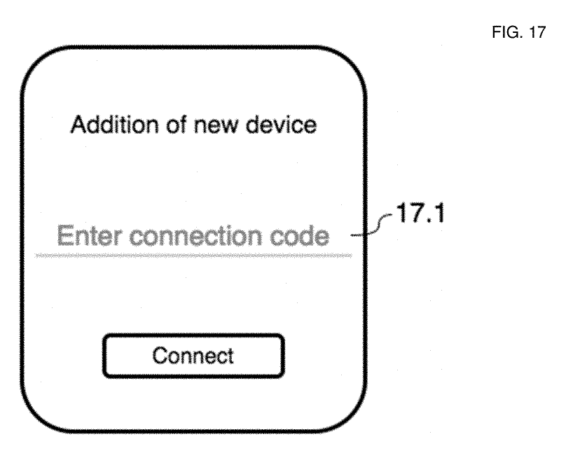

FIG. 17 presents an example of interface of a broadcast device used to connect it to the program. To establish connection, the access code generated at the previous step shall be entered into input field 17.1. If the code has been entered correctly, the broadcast device connects to the program and becomes controllable from CMS and Editor. It is then set up as required from CMS, Editor, or the device itself.

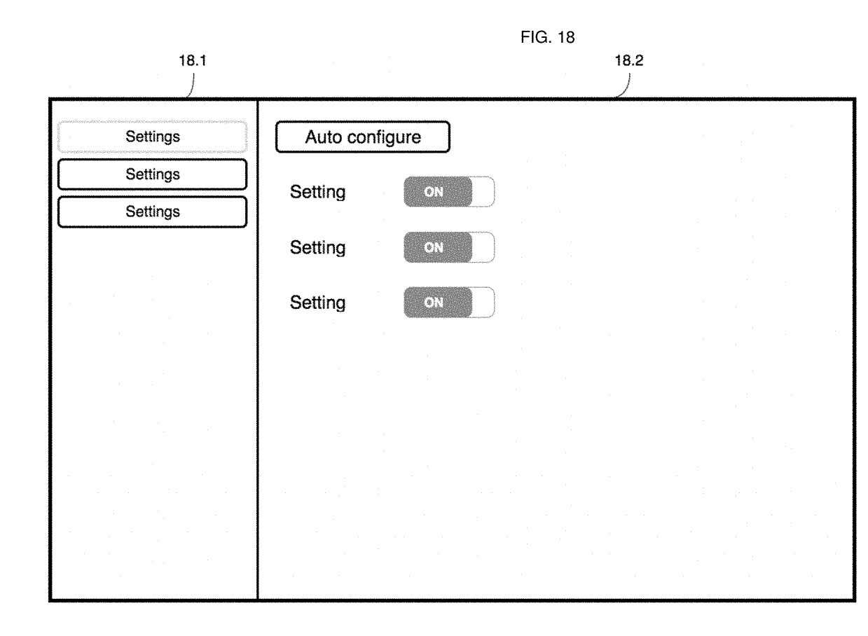

FIG. 18 presents an example of interface for for on-site setup of a broadcast device. The interface includes:
settings group selection panel 18.1;
main workspace for view and adjustment of settings of selected group 18.2.

The interface enables autoconfiguration of broadcast device for quick preparation to advertising campaign playback. It also allows making changes to some device settings.

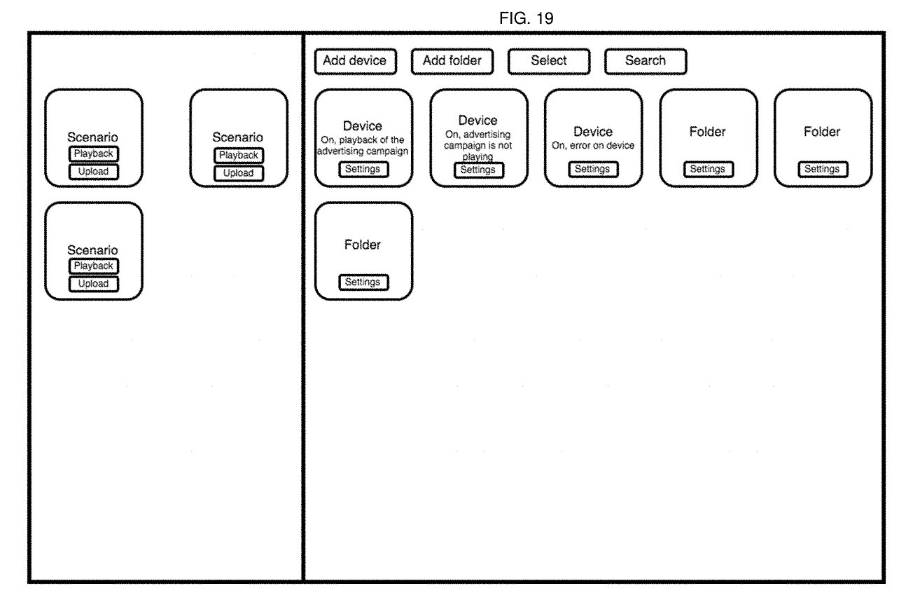

FIG. 19 presents an example of Editor control panel. The control panel provides the same options for broadcast device management as CMS (described above). Icon of each broadcast device reflects its current status—whether there is connection with CMS and Editor, whether an advertising campaign is played. In addition, Editor control panel enables the following:
trial playback of advertising campaign scripts;
upload of advertising campaign scripts into CMS.

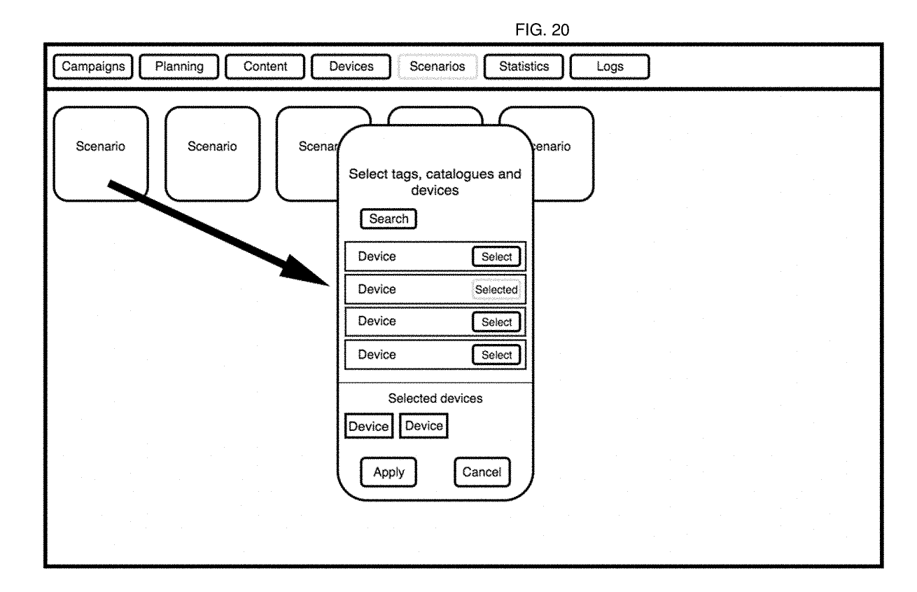

FIG. 20 present an example of simplified interface for deployment of an advertising campaign on broadcast devices. The interface enables the user to launch a script in several clicks: 1—selection of script, 2—selection of one or more devices, 3—launch. After launch, the script is played on selected broadcast devices according to their settings.

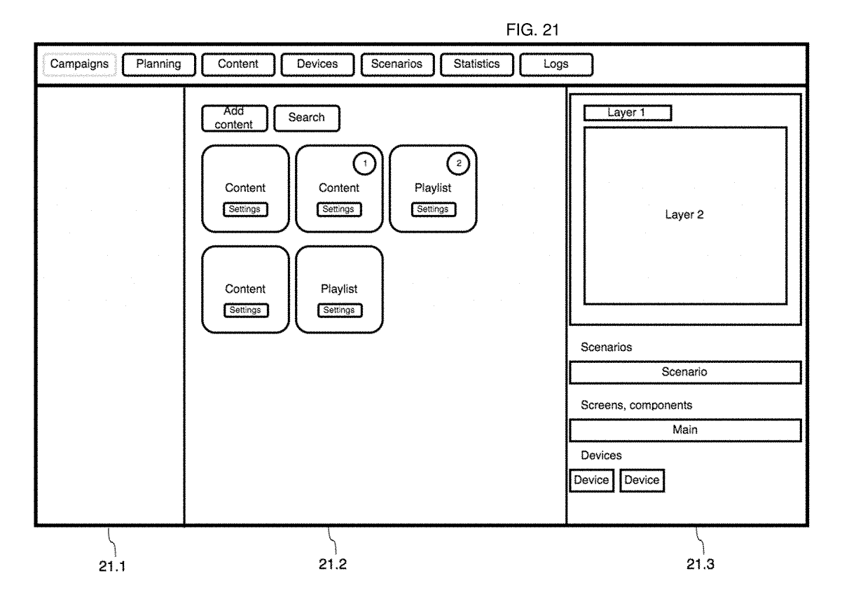

FIG. 21 presents an example of interface for advertising campaign management. The interface includes campaign features panel 21.1, content area 21.2, and settings panel 21.3. Campaign features panel 21.1 is used to set the campaign title, status (on /off), duration, and target audience settings. Also the features panel 21.1 reflects data on views conversion (described below) and provides access to viewing campaign reports (described below). Content area 21.2 displays content that is added via CMS and can be placed into the advertising campaign without using Editor. In addition, the content area 21.2 provides options for adding content and for filtering it, e.g. “Show all content not used in the advertising campaign”. Any multimedia content can be grouped into playlist. Playback schedule and rules can be set for both individual content elements and playlists. Such settings include:
period during which the content will be displayed;
days of the week on which the content will be displayed;
time of day;
audience settings—gender and age.

Content can be added to the advertising campaign without using Editor. Prerequisite for this is toggling respective settings of layers and components in the advertising campaign script in Editor (described above). After that, to add content from CMS:
1. Settings panel 21.3 is used to select the script used in the advertising campaign;
2. Campaign components and screen are them selected, containing layers or components that have CMS indicated as a source of content;
3. The content is dragged into respective component or layers in settings panel 21.3.

After the content has been placed in the advertising campaign, it will be displayed on connected broadcast devices according to their operation schedule and content display settings. Content icon will be marked with an indicator showing the number of layer or component the content has been assigned to.

Settings panel 21.3 also contains the list of broadcast devices the advertising campaign will be run on and enables the user to add new broadcast devices to the advertising campaign. The interface used for this is similar to the one described above.

After the advertising campaign settings have been saved with the “On” status, it will be automatically included into advertising campaigns display plan (Mediaplan).

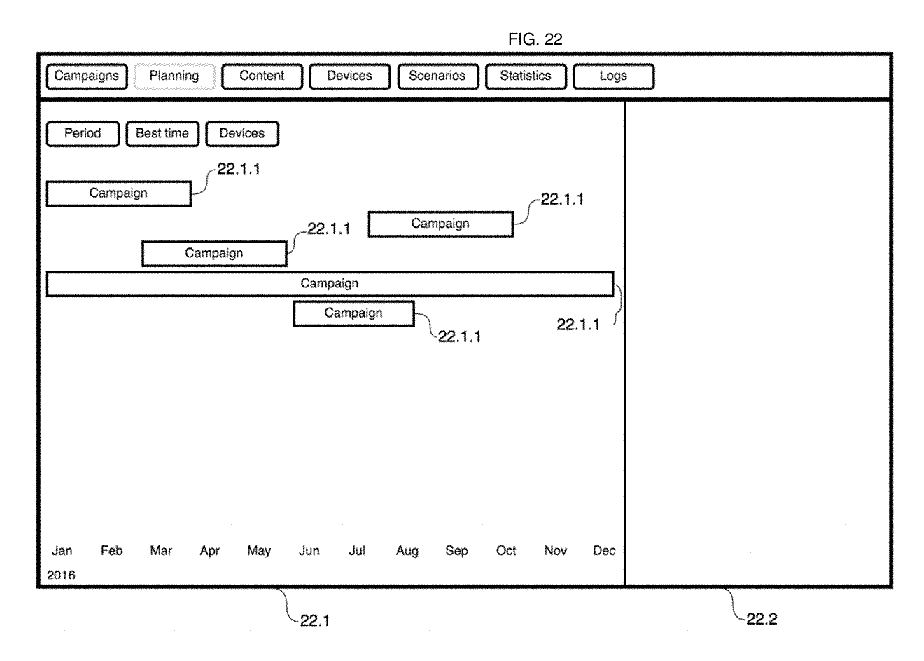

FIG. 22 presents an example of interface for advertising campaign planning. The interface includes main workspace 22.1 and campaign settings panel 22.2. Main workspace 22.1 contains Calendar, which reflects duration of active (“On”) campaigns 22.1.1. In addition, main workspace enables the following:
Calendar period settings;
display of time periods most appropriate for advertising campaign playback, based on data received from external sources and integrated into the campaign, e.g. sales data from ERP systems, foot traffic sensors, data from cameras on content view duration, etc.;
display of information on campaigns launched on selected broadcast devices.

Campaign settings panel allows changing duration and schedule of each campaign, including the possibility of setting several different time periods within the same day, e.g. 10 AM to 1 PM, 3 PM-6 PM.

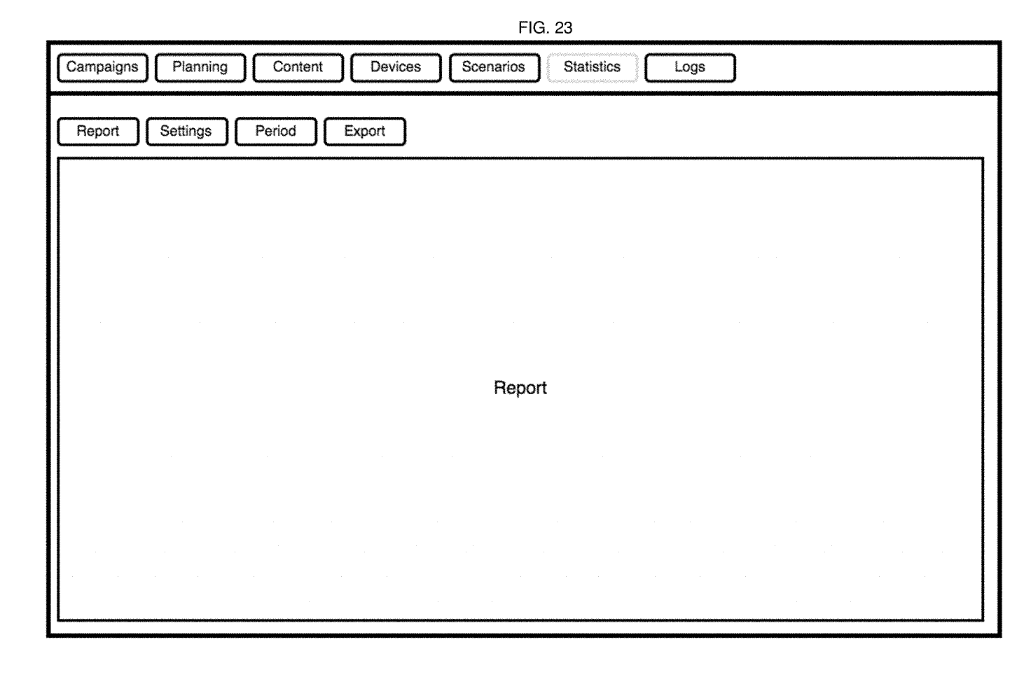

FIG. 23 presents an example of interface for monitoring and analysis of advertising campaigns. The interface enables report selection, setting of report parameters, e.g. stages of conversion funnel (described below), setting of reporting period, report view and export. The following types of reports are offered:
conversion of views—how many persons have looked on broadcast device screen, how many persons have been prompted to interact with the broadcast device thereafter;
audience profile—data on gender and age of persons who have looked on broadcast device screen;
views history—list of data (ID, date and time, facial photo, broadcast device) on all persons who looked towards the broadcast device camera for more than 1-2 seconds;
clicks and transitions—data on customers' interaction with advertising campaigns on broadcast devices, e.g., which components and screens have been launched, which content displayed, etc.;
conversion funnel—used for analysis of the distribution of advertising campaign target audience over stages of the sales process, from the number of persons detected in the area by foot traffic sensor and all persons passing by video cameras of broadcast devices to the number of customers who have purchased monitored goods;
findings of A/B-testing of advertising campaigns—used to compare different advertising campaigns or different content within the same advertising campaign for efficiency.

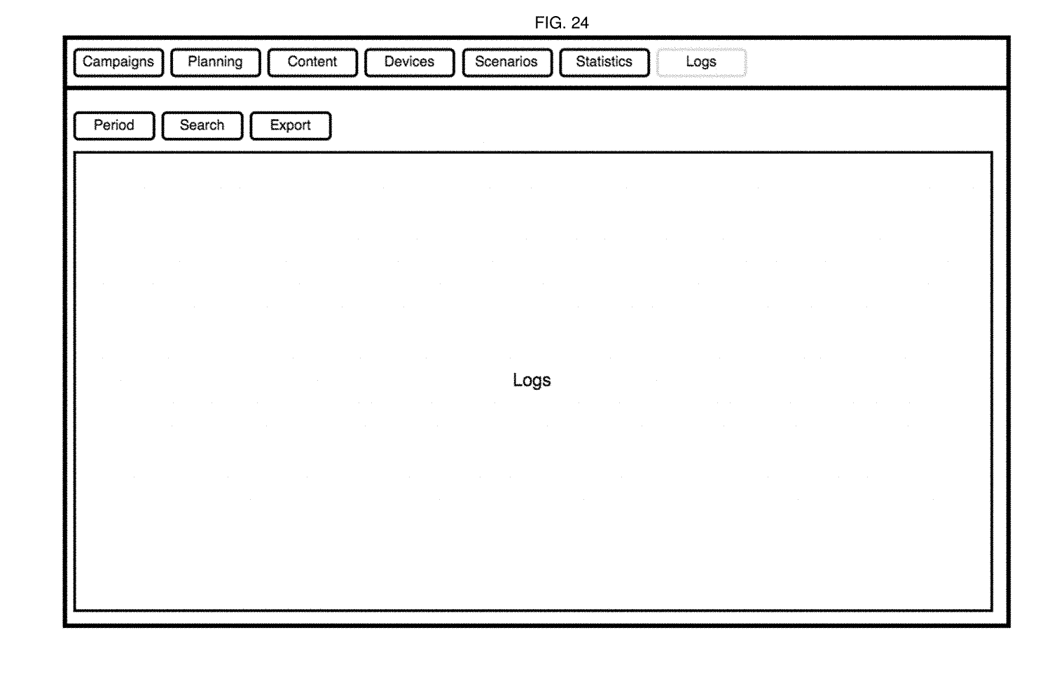

FIG. 24 presents an example of interface for viewing logs. The interface allows review of everything that happened in the program and on broadcast devices (changes to settings, advertising campaign launch, device availability, etc), as well as data export. Data can be filtered by time period and technical parameters, such as:
entry type—notification, error message;
broadcast device OS;
entry source—broadcast device, advertising campaign, program, content, Player, Editor, CMS.

1. A method for creation, playback, management, and monitoring of multimedia advertising campaigns on digital devices by use of software program, said method comprising:
(a) method for creation of a multimedia advertising campaign is accomplished by development of a script for its playback on the basis of functional elements by the user;
wherein script may include content, components, triggers, and directed links between its elements;
wherein the content can be text, sound, images, audio and video; it can be both static and dynamic; content is obtained from an external source selected for the purpose;
wherein the components are intended for gathering, processing, and playback of content;
wherein the triggers allow linking occurring events to the script or content of the campaign being changed;
(b) a method of controlling digital devices intended for playback of advertising campaigns playback; a method of centralized devices control including connection, configuration, and availability monitoring;
wherein
1. a user adds new broadcasting devices;
2. unique connection code is generated for each new device;
3. a user installs player software on each broadcasting device and inputs the connection code;
4. establishment of connection between the broadcasting devices, personal account and templates' editor, after that the broadcasting device becomes available for remote management and advertising campaigns launching;
5. a user configures a broadcasting device from the personal account, templates' editor or locally on the player;
6. a user periodically checks the broadcasting devices' statuses from the personal account;
7. a user gets a notification in case of problems with broadcasting devices.
(c) a method of advertising campaigns on digital broadcasting devices;
using directed links between the script elements allows to set up the advertising campaign playback sequence;
whereby the designed advertising campaign is centrally uploads to one or more broadcasting devices, after which it starts to playback;
specific playback details are assigned to the script to adjoining broadcast devices;
wherein
1. a user centrally uploads an advertising campaign to one or more broadcasting devices;
2. an advertising campaign broadcasts and adapts to the device in accordance with the playback scenario.
(d) a method to manage the broadcasting devices centrally, including quick activation and monitoring availability;
management and monitoring of advertising campaigns is accomplished by CMS;
a user plans a playback schedule for advertising campaigns, changing of the campaign script or its specific element;
a user updates advertising campaign content without current broadcast stopping or modifying the script;
a user stops the playback of the campaign on the broadcasting devices;
a user delete the campaign;
wherein
1. a user creates the statistical reports on the advertising campaigns, analyses the indicators and makes a decision about the future changes;
2. a user can change the content or a script of an advertising campaign without current broadcast stopping, advertising campaign updates automatically;
3. a user can stop the broadcasting of an advertising campaign on one of the devices or on all of them.
(e) a method for monitoring and analyzing the advertising campaigns having taking into account various performance indicators of advertising campaigns;
the indicators are primarily audience-based and include: customer engagement, gender, age, optimal time for advertisement playback;
a provision is made for analysis of interrelations between number of sales and the advertising campaign, and between monitoring and interpretation of any other data obtained from external source integrated into the campaign;
the method also provides for A/B-testing of campaigns;
reliance on findings of advertising campaign analysis enables the user to make decisions on modifications of campaign elements or of the overall corporate marketing strategy, for the purpose of improving efficiency.

2. The method of claim 1, wherein
(a) the user in charge of creation of the advertising campaign defines types of content to be used in the script;
(b) depending on the type of content required the user adds a component to the script;
(c) the user places content or links to sources from which this content will be transmitted into the added component;
(d) the user configures the component;
(e) the user determines the necessity for using triggers; if response to external events is needed the user adds a corresponding trigger to the script; if there is no need for triggers, go to step (f);
(f) the user verifies if all types of content have been accounted for and all components for content playback have been added; If something has not been added, return to step (a); if everything is in, go to step (g);
(g) the user determines if links within and between components and triggers of the script are required; if they required, go to step (h), otherwise, go to step (k);
(h) the user determines the script playback sequence;
(i) the user adds links within components, between components, and between components and triggers; in this way the script acquires a playback sequence;
(j) the user verifies if all links have been added; if all links have been added, go to the last step; if not all links have been added, return to step (h);
(k) the user saves the script.

3. A method in claim 1, wherein connection of a broadcast device is accomplished by:
(a) the user in charge of broadcast device connection undergoes authentication in CMS;
(b) the user goes to the devices management section;
(c) the user adds a new broadcast device;
(d) the user enters name of the added device;
(e) an access code is generated, which later has to be entered in to the broadcast device;
(f) the user determines whether it is necessary to download the latest version of Player software; if download is required, the user downloads the program distribution, otherwise, go to step (g);
(g) the user installs Player software the broadcast device;
(h) the user launches Player on the broadcast device;
(i) the user enters the access code generated at step (e);
(j) access code verification is performed, if the code has been entered correctly, go to (k), otherwise, return to (i);
(k) a connection between the broadcast device, CMS, and Editor is established, while the broadcast device becomes visible in the respective section if CMS and in Editor and available for management and playback of advertising campaigns.

4. The method of claim 1, wherein
a software with graphical user interface serves for implementation of the above mentioned method;
a software platform is suggested, including the following elements:
Editor—for creation and management of advertising campaign scripts, centralized control of broadcast devices;
Player—for playback of advertising campaigns on broadcast devices, local control of broadcast devices;
Content Management System (CMS)—for management, monitoring, and analysis of advertising campaigns, control of broadcast devices;
Backend—for organizing interaction between the above-listed components.
